(19) United States
(12) Patent Application Publication
(10) Pub. No.: US 2011/0300369 A1
(43) Pub. Date: Dec. 8, 2011

(54) METHOD FOR RECYCLING CURED FOAM INSULATION FOR USE IN INSULATING CAVITIES OF DEVICES REQUIRING THERMAL INSULATION

(76) Inventors: Jean-Claude Lesage, Kirkland (CA); Marc Archambault, L'Assomption (CA)

(21) Appl. No.: 12/848,249

(22) Filed: Aug. 2, 2010

(30) Foreign Application Priority Data
Jun. 3, 2010 (CA) 2,706,263

(51) Int. Cl. B32B 3/10; B29C 73/02

(52) U.S. Cl. 428/304.4; 264/36.11

(57) ABSTRACT

A method of recycling cured foam insulation having an internal cell/bubble structure is described. The method comprises cutting the cured foam cell insulation into foam pieces of predetermined sizes and shape dependent on the dimensions of cavities to be insulated and incorporating the foam pieces therein. A predetermined volume of the cavities is filled with the foam pieces and a predetermined quantity of an expandable liquid foam insulation is injected into the cavities containing the foam pieces and caused to expand to fill voids in the cavities with the foam pieces forming a homogeneous insulating foam body throughout the cavities while retaining substantially their internal cell/bubble structure.

### TECHNICAL FIELD

The present invention relates to the recycling of insulating cured foam material having an internal cell/bubble structure for re-use in combination with an expandable liquid foam insulation material.

### BACKGROUND ART

Household and commercial appliances that either heat or cool a medium, such as a refrigerator or a water heater, require insulation to increase their energy efficiency. Originally, fiberglass type insulations were used to insulate these appliances. In the 1970's polyurethane foam type insulation was introduced and rapidly replaced fiberglass insulation due to advantages related to manufacturing processes and energy efficiency. Generally, two liquid chemicals are mixed together as they are injected into an empty cavity of the appliance. The chemical reaction causes the materials to expand in volume and fill the empty cavity prior to solidifying. It also creates an extremely small bubble structure within itself which acts as the insulator. Some of the drawbacks of this type of technology are that it is a one-time reaction that cannot be reversed. Other problems associated with this is that the material cannot he re-used in another appliance which means insulation scraps generated during the manufacturing process as well as the waste generated at the end of the product's life end up in landfills since generally these materials cannot be recycled. This is a critical issue since environmental problems are on the rise and the cost and availability of the raw materials for the fabrication of these types of products will become more and more restrictive since they are derived from petroleum sources.

### SUMMARY OF INVENTION

It is a feature of the present invention to provide a means of recycling cured foam insulation material to overcome the deficiencies of the prior art as disclosed herein.

According to a broad aspect of the present invention there is provided a method of recycling cured foam insulation having an internal cell/bubble structure is described. The method comprises cutting the cured foam cell insulation into foam pieces of predetermined sizes dependent on the dimensions of cavities to be insulated and incorporating the foam pieces therein. A predetermined volume of the cavities is filled with the foam pieces and a predetermined quantity of an expandable liquid foam insulation is injected into the cavities containing the foam pieces and caused to expand to fill voids in the cavities with the foam pieces forming a homogeneous insulating foam body throughout the cavities while retaining substantially their internal cell/bubble structure.

### BRIEF DESCRIPTION OF DRAWINGS

The invention will now be described with the accompanying drawings in which:

FIG. 1 is a cross-section view of a cube of cured foam insulation having an internal cell/bubble structure and used for recycling in combination with an expandable liquid foam insulation material;

FIG. 2 is a fragmented section view showing the cured foam pieces positioned in a cavity surrounding an inner tank of a water heater and restrained by an outer shell;

FIG. 3 is a section view similar to FIG. 2 but showing liquid foam being injected into the cavity in which the recycled foam pieces have been disposed to form a homogeneous insulation foam body throughout the cavity and about the inner tank of the water heater.

### DESCRIPTION OF PREFERRED EMBODIMENTS

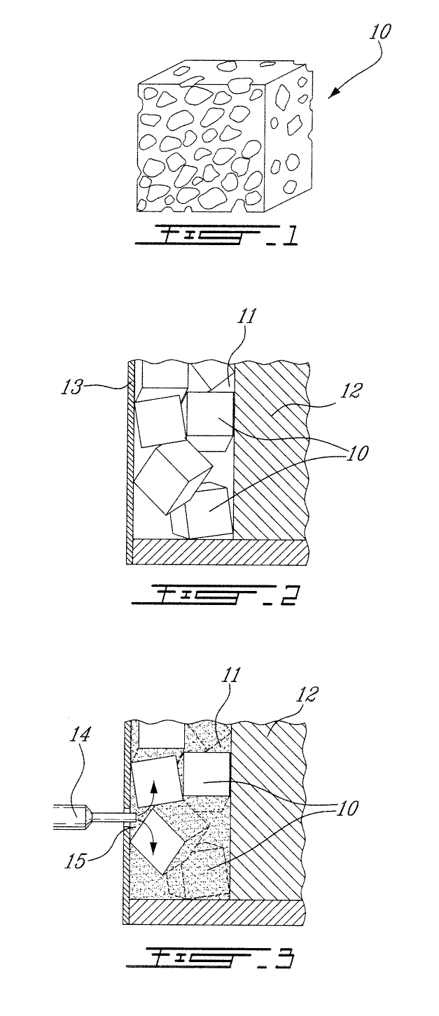

Referring to FIG. 1, there is shown a foam cube 10 cut from a cured foam structure which has been removed from an appliance, such as a hot water heater which has served its life cycle or other such foam structures recovered from other types of devices or appliances. These foam cubes 10 are a predetermined size depending on their application and as described hereinbelow and they are herein shown in FIG. 2 re-used to insulate a surrounding cavity 11 surrounding an inner tank 12 of a hot water heater. As hereinshown, only a fragmented portion of the bottom section of the hot water heater is shown in a fragmented view. An outer casing 13 is secured spaced from the inner tank 12 to create the cavity 11. The cubes of recycled foam 10 are placed in this cavity in predetermined quantities whereby they occupy approximately 12% by foam weight of the new foam to be injected into the cavity 11. FIG. 3 shows an injection nozzle 14 injecting a new foam material 15 into the cavity 11 whereby a homogeneous insulating foam body is created in the cavity to insulate the inner casing.

The scope of this patent application pertains to a method developed and tested for the recycling of cured and/or older recuperated foam insulation in water heaters, or any other type of appliance that uses such foam insulation. The primary obstacle to this concept is that older/aged foams, as well as plant reprocessed foam, can have a lower insulating performance compared to 100% new foam coating. Furthermore, the new foam coating, when injected as a liquid, completely fills the empty voids and adheres to the appliance surfaces as it reacts to form a perfect insulator. If one was to simply wrap or fill the empty appliance cavity with used insulation, this type of system would not fill all the voids and hence create thermal bridges that would waste energy.

The proposed principal for this patent application is to combine a calculated and/or ratio of reacted/solidified/used foam insulation with new foam insulation. In other words, a portion of used rigid foam is placed in the empty appliance cavity that needs to be filled. Then, the liquid foam is poured into the cavity. This latter application fills all of the voids left over by the rigid insulation and assimilates it into the new foam structure as the chemicals react.

The key for this principal to work is that the used insulation must have a defined size and shape. Otherwise, instead of contributing to the insulation performance of the overall system, it will cause it to deteriorate. This was determined by experimentation when solid cured foam was ground-up into a fine powder and mixed with new foam. It was quickly realized that that technique was not feasible as energy performance levels for the insulated experimental water heaters showed far worse results than those insulted strictly with new foam.

Another experimental technique was to cut pieces of cured foam into small cubes, 2″×2″×2″, and dropped into the empty cavity around the inner tank and the outer jacket of a water heater prior to the new foam injection. The cavity was then injected with the remaining requirement of foam to fill the void, i.e., if you need a total of 5 pounds of cured foam to fill the void of a given water heater size and you put 1 pound of cured foam into the void, you need only to add 4 pounds of new foam.

These prototypes where then tested for energy performance and revealed to be just as good as units with new foam. In other words, lab results could not tell the units apart in regards to their respective energy performance numbers.

In order to verify our findings, we then proceeded with a second series of tests with cubes of 1″×1″×1″. These units also revealed that energy performance numbers could be just as good with a small amount of recycled foam mixed with new foam versus only new foam.

What can be deducted from these findings is that the key to this recycling of cured foam lies in the integrity of the foam structure of the pieces of cured foam. In other words, it is crucial that the foam pieces contain a cell structure in order to have them retain their insulating properties.

From our experimental findings, we can conclude that contrary to the claims of foam systems providers, used/cured foam can be efficiently recycled. The principle is that pieces of cured foam placed in the fillable void need to retain their internal bubble (cell) structure to allow them to retain their insulating properties. Care must be taken in the cutting/dismantling process in order to avoid damaging the bubble structure of the cured foam. The size of the pieces should be close to yet below the actual finished foam cavity for ease of assembly and proper mixing of the two foam mediums (liquid and solid), i.e., if a water heater requires 2″ of cured foam for proper insulation, 1″ thick pieces of cured foam gives exceptionally good results. Our experiments show that we can combine up to about 10% to 12% by foam weight of cured foam in a new appliance insulating cavity. However, these results were obtained with cured foam derived from the same foam system used at a designated plant. If one was to combine other types of foam, such as recuperated from older defective units, caution must be taken as aged foam or foam made from a different system may have less insulating properties than the one in use at the plant. Therefore, the quantity of used foam should be reduced accordingly in order to minimize the negative effect such lower quality foam may have on the energy performance numbers of an appliance. One can therefore significantly reduce its carbon footprint and overall consumption of petroleum-made raw materials by recycling cured foams. Also, this results in a significant reduction of land fill waste produced by cured foam derived from production chain rejected units, warranty defective units and obsolete/end-of-life units, since their insulation can be re-used in new products instead of being discarded and shipped to waste management sites. It is further pointed out that this method can he applied to numerous processes not limited to water heaters or appliances. It is important to note that in recycling the foam, there is substantially no alteration of the cured foam bubble structure.

Although the insulating foam used in the experimentation was a rigid polyurethane foam as used to insulate hot water heaters, the present invention is not intended to be restricted to such foams and other expandable insulating foam types are intended to be covered. Further, although the cured foam insulating pieces are shown as being of cubic form, they could also be of any other shape provided an internal cell/bubble structure is maintained to provide the insulating properties. For example, recycled foam may be broken down into nugget shapes of sufficient dimension to retain its cell/bubble structure in its mass. It is further pointed out that when the liquid foam is injected into the cavity it does not melt the cured foam pieces but merely integrates them into the newly formed rigid foam structure with the new foam filling all of the voids about these foam cubes.

We claim:

1. A method of recycling cured foam insulation having an internal cell/bubble structure, said method comprising the steps of:
i) cutting said cured foam insulation into foam pieces of predetermined sizes dependent on the dimensions of cavities to be insulated and incorporating said foam pieces therein;
ii) filling a predetermined volume of said cavities with said foam pieces;
iii) injecting a predetermined quantity of expandable liquid foam insulation into said cavities containing said foam pieces and causing it to expand to fill voids in said cavities with said foam pieces forming a homogeneous insulating foam body throughout said cavities while retaining substantially their internal cell/bubble structure.

2. A method as claimed in claim 1 wherein said step (i) comprises cutting said foam pieces to a predetermined size smaller than an opening leading to said cavities.

3. A method as claimed in claim 1 wherein said step (ii) comprises filling about 12% by foam weight of said cavities with said foam pieces.

4. Recycled cured foam adapted for use in combination with expandable liquid foam insulation to insulate a cavity of an article to be insulated, said foam pieces having a predetermined size and having an internal cell/bubble structure whereby to form a homogenous insulating foam body with said expandable liquid foam when expanded in admixture therewith.

5. Recycled foam pieces as claimed in claim 4 wherein said foam pieces are polyurethane foam pieces.
